(19) United States
(12) Patent Application Publication
(10) Pub. No.: US 2007/0013143 A1
(43) Pub. Date: Jan. 18, 2007

(54) Filled hydrodynamic seal with contact pressure control, anti-rotation means and filler retention means

(75) Inventors: John E. Schroeder, Houston, TX (US); Jeffrey D. Gobeli, Hosuton, TX (US); Lannie L. Dietle, Houston, TX (US)

Correspondence Address: ANDREWS & KURTH, L.L.P., 600 TRAVIS, SUITE 4200, HOUSTON, TX, 77002, US

(73) Assignee: Kalsi Engineering, Inc.

(21) Appl. No.: 11/488,746

(22) Filed: Jul. 18, 2006

Related U.S. Application Data
(60) Provisional application No. 60/700,237, filed on Jul. 18, 2005.

(51) Int. Cl. F16J 15/32

(52) U.S. Cl. 277/551

(57) ABSTRACT

A preferred embodiment of a sealing assembly for partitioning a first fluid from a second fluid includes a first machine component defining a seal groove adjoined to a pocket recess and a second machine component having a relatively rotatable surface. A rotary seal is in sealing engagement with the first and second machine components. The rotary seal includes a seal body of generally ring-like construction. The seal body has a predetermined modulus of elasticity and defines a dynamic sealing lip having a dynamic sealing surface. The seal body has an annular recess defining a plurality of retaining ridges and retaining depressions. The annular recess has a first volume in an uninstalled condition and a compressed volume when the rotary seal is in sealing engagement with the first and second machine components. An energizer element is positioned in the annular recess and engages the plurality of retaining ridges and depressions in the annular recess. The energizer element has a modulus of elasticity that is different than the predetermined modulus of elasticity of the seal body. The energizer element has a volume in the compressed condition that is no greater than the compressed volume of the annular recess. An anti-rotation projection engages the seal body and extends from the seal body into the pocket recess of the first machine component.

### CROSS-REFERENCE TO RELATED APPLICATIONS

This application claims the benefit of U.S. Provisional Application Ser. No. 60/700,237 filed on Jul. 18, 2005, entitled “Filled Hydrodynamic Seal With Contact Pressure Control, Anti-Rotation Means and Filler Retention Means.”

### BACKGROUND OF THE INVENTION

1. Field of the Invention

The present invention pertains to the field of hydrodynamic rotary shaft seals that are suitable for the retention of pressurized fluids.

2. Description of the Related Art

FIGS. 1 and 1A of this specification represent prior art which is discussed briefly herein to enhance the reader's understanding of the distinction between prior art hydrodynamic seals and the present invention. FIG. 1 is a fragmentary cross-section of the uninstalled prior art seal, and FIG. 1A is a fragmentary cross-section of the installed seal. The rotary seal of FIGS. 1 and 1A is constructed in accordance with the teachings of commonly assigned U.S. Pat. No. 5,738,358 and its FIG. 15, and FIG. 2D of commonly assigned U.S. Patent Application Publication No. US2005/0093246.

The prior art seal is constructed with a seal body 2 and an energizer 3 that are made of resilient sealing materials such as elastomers. The seal body 2 is typically a higher modulus of elasticity material section, and the energizer 3 is typically a lower modulus material section. The energizer 3 is located within an annular recess 4 of the seal body 2. In the uninstalled state (FIG. 1), the energizer 3 is substantially flush with the environmental end 5 of the seal body 2.

The resilient materials that are used to construct the seal body 2 and the energizer 3 of the prior art seals are essentially “incompressible,” which means that if the seals are compressed (i.e., squeezed) in one direction when installed, they bulge out at other locations to compensate, and the actual volume remains approximately constant. In other words, the Poisson's Ratio of such materials is approximately 0.5.

As shown in FIG. 1A, when such a seal is installed in radial compression between a relatively rotatable surface 6 and a peripheral wall 7 of a seal groove 8, a portion of the energizer 3 is displaced axially by the radial compression, and bulges past the environmental end 5 of the seal body 2. This is because the volume of the annular recess 4 diminishes when the seal is installed, such that in the installed condition the volume of the prior art energizer 3 exceeds the volume of the annular recess 4.

When a lubricant 9 is pressurized, it acts on the seal over Pressure Area A, which is defined between the relatively rotatable surface 6 and the peripheral wall 7 of the seal groove 8. The pressure of the lubricant 9 acting over Pressure Area A forces the energizer 3 against an environment-side groove wall 10. The seal contacts the environment-side groove wall 10 over Reaction Area B due to the energizer 3 bulging past the environmental end 5 of the seal body 2. Since the Pressure Area A is significantly larger than the Reaction Area B, the contact pressure between the energizer 3 and the environment-side groove wall 10 at Reaction Area B is significantly higher than the pressure of the lubricant 9. The contact pressure at Reaction Area B is approximately equal to the pressure of the lubricant 9 multiplied by Pressure Area A divided by Reaction Area B. The contact pressure is transmitted through the energizer 3 in approximately the same manner as if the energizer 3 were a fluid, and forces a dynamic sealing lip 11 against the relatively rotatable surface 6 with much more force than would otherwise occur in the absence of lubricant pressure. As a result of this area ratio-related pressure amplification effect, the interfacial contact pressure in the dynamic interface between the dynamic sealing lip 11 and the relatively rotatable surface 6 is much higher than it would be in the absence of lubricant pressure, and much higher than it would be if the energizer 3 did not bulge past the end of the seal body 2. The increased contact pressure makes the seal much harder to lubricate hydrodynamically, and makes the seal run with much higher torque and self-generated heat than it would if the energizer 3 did not bulge past the environmental end 5 of the seal body 2. As a result, the seal wears out quicker, and must be limited to lower speeds to avoid overheating.

Commonly assigned U.S. Pat. No. 5,738,358 states that the energizer 3 can be a castable elastomeric material. This has the advantage of eliminating the large cross-sectional tolerance associated with seals that have a separately molded energizer. If the energizer 3 is a material with poor abrasion resistance, such as castable silicone, it will abrade away if the seal slips rotationally in the seal groove 8 due to running torque. Experience reveals that silicone typically doesn't abrade away evenly, but instead breaks away in uneven chunks. Such chunks have the potential to become lodged between the environmental end 5 of the seal and the environment-side groove wall 10, disrupting the intended circularity of the dynamic exclusionary intersection 12, and thereby causing skew-induced ingestion of abrasives that may be present in the environment 13. This results in premature abrasion of the dynamic sealing lip 11 and the relatively rotatable surface 6. If the seal slips rotationally in the seal groove 8, the peripheral wall 7, static sealing surface 26, environmental end 5 and environment-side groove wall 10 may also experience undesirable wear.

Many castable elastomeric materials have poor adhesion qualities, and when they are used to form the energizer 3, they do not bond well to the seal body 2. This poor bonding can result in physical loss of the energizer 3, and other problems, such as a change in the compressive characteristics of the seal.

The problems described above are repeated in the dual modulus seals of commonly assigned U.S. Pat. Nos. 6,685,194 and 6,767,016. In fact, the convex environmental end shape of the dual modulus seals with C-shaped seal bodies, shown in U.S. Pat. Nos. 6,685,194 and 6,767,016, facilitates the area ratio-related pressure amplification problem described herein.

As shown in FIGS. 1 and 1A, a molded anti-rotation projection 14 of sealing material, molded integral with the seal body 2, can be used to engage a pocket 15 in a lubricant side groove wall 16 of the seal groove 8 for anti-rotation purposes, in accordance with the teachings of FIG. 2D of commonly assigned U.S. Patent Application No. US2005/0093246. This works well only in applications where the pressure of the environment 13 is never significantly higher than the pressure of the lubricant 9.

To fit, the anti-rotation projection 14 must necessarily be formed smaller than the pocket 15 due to size and location tolerances of the anti-rotation projection 14 and the pocket 15, and due to differential thermal expansion between the anti-rotation projection 14 and the pocket 15. As a result, significant clearance must exist between the anti-rotation projection 14 and the pocket 15 when assembled. If the pressure of the environment 13 is higher than the pressure of the lubricant 9, the resulting differential pressure acting on the seal will cause the seal to deform into the clearance between the anti-rotation projection 14 and the pocket 15. This seal deformation can cause the dynamic exclusionary intersection 12 to skew and/or locally lift away from the relatively rotatable surface 6, which can cause the environment 13 to be swept into the dynamic sealing interface between the dynamic sealing lip 11 and the relatively rotatable surface 6. If the environment contains abrasives, the abrasives will quickly wear the dynamic sealing lip 11 and the relatively rotatable surface 6. Thus, the molded anti-rotation projection 14 is not suitable for applications where the pressure of the environment 13 is significantly higher than the pressure of the lubricant 9.

### SUMMARY OF THE INVENTION

The preferred embodiment of the present invention solves the aforementioned problems by controlling the volume of the energizer so that it does not exceed the volume of the annular recess when the seal is in the installed condition. Additionally, the seal of the preferred embodiment includes a mechanical interlock between the seal body and the energizer to relieve stress on the bond. With respect to preventing seal rotation within the seal groove, the preferred embodiment of the present invention includes an anti-rotation projection including the features of preventing rotation of the seal within the seal groove that are immune to reverse pressure and protecting the seal from skew-induced wear in a condition where the environment pressure is higher than the lubricant pressure.

A preferred embodiment of the sealing assembly for partitioning a first fluid from a second fluid includes a first machine component defining a seal groove adjoined to a pocket and a second machine component having a relatively rotatable surface. A rotary seal is in sealing engagement with the first and second machine components. The rotary seal includes a seal body of generally ring-like construction. Preferably, the seal body has a predetermined modulus of elasticity and defines a dynamic sealing lip having a dynamic sealing surface. The seal body preferably has an annular recess defining a plurality of retaining ridges and retaining depressions. The annular recess has a first volume in an uninstalled condition and a second volume when the rotary seal is in compressed, sealing engagement with the first and second machine components. Preferably, an energizer is positioned in the annular recess and engages the plurality of retaining ridges and depressions in the annular recess. The energizer has a modulus of elasticity that is different than the predetermined modulus of elasticity of the seal body. The energizer has a volume in the compressed condition that is no greater than the second volume of the annular recess. In the preferred embodiment, an anti-rotation projection engages the seal body and extends from the seal body into the pocket of the first machine component.

### BRIEF DESCRIPTION OF THE SEVERAL VIEWS OF THE DRAWINGS

So that the manner in which the above recited features, advantages, and objects of the present invention are attained and can be understood in detail, a more particular description of the invention, briefly summarized above, may be had by reference to the embodiments thereof which are illustrated in the appended drawings. It is to be noted, however, that the appended drawings only illustrate typical embodiments of this invention, and are therefore not to be considered limiting of its scope, for the invention may admit to other equally effective embodiments.

In the drawings:

FIG. 1 is a fragmentary cross-section of a prior art seal in an uninstalled condition;

FIG. 1A is a fragmentary cross-section of the prior art seal of FIG. 1 shown in an installed condition;

FIG. 2 is a fragmentary cross-section of a seal according to a preferred embodiment of the present invention, the seal shown in an uninstalled condition;

FIG. 2A is a fragmentary cross-section of the seal of FIG. 2 shown in an installed condition;

FIG. 3 is a fragmentary cross-section of a seal according to a second preferred embodiment of the present invention, the seal shown in an uninstalled condition;

FIG. 3A is a fragmentary cross-section of the seal of FIG. 3 shown in an installed condition;

FIGS. 4-7 are fragmentary cross-sections of simplified seal embodiments in which the anti-rotation pin has been eliminated, the simplified embodiments shown in their uninstalled condition;

FIGS. 8-11 are fragmentary cross-sections of simplified seal embodiments in which the energizer has been eliminated, the simplified embodiments shown in their uninstalled condition;

FIG. 12 is a fragmentary cross-section of a seal according to another preferred embodiment of the present invention, the seal shown in an uninstalled condition;

FIG. 12A is a fragmentary cross-section of the seal of FIG. 12 shown in an installed condition;

FIG. 13 is a fragmentary cross-section of a filling fixture for holding the seal body in a partially compressed condition during the forming of the energizer;

FIG. 14 is a fragmentary cross-section of a simplified seal embodiment in which the energizer has been eliminated from the annular recess, the simplified embodiment shown in the uninstalled condition; and

FIGS. 15 and 16 are fragmentary cross-sections of alternative seal embodiments in which the energizer is in the form of a mechanical spring, the alternative seal embodiments are flexing cantilever lip type seals shown in their uninstalled condition.

### DESCRIPTION OF THE EMBODIMENTS

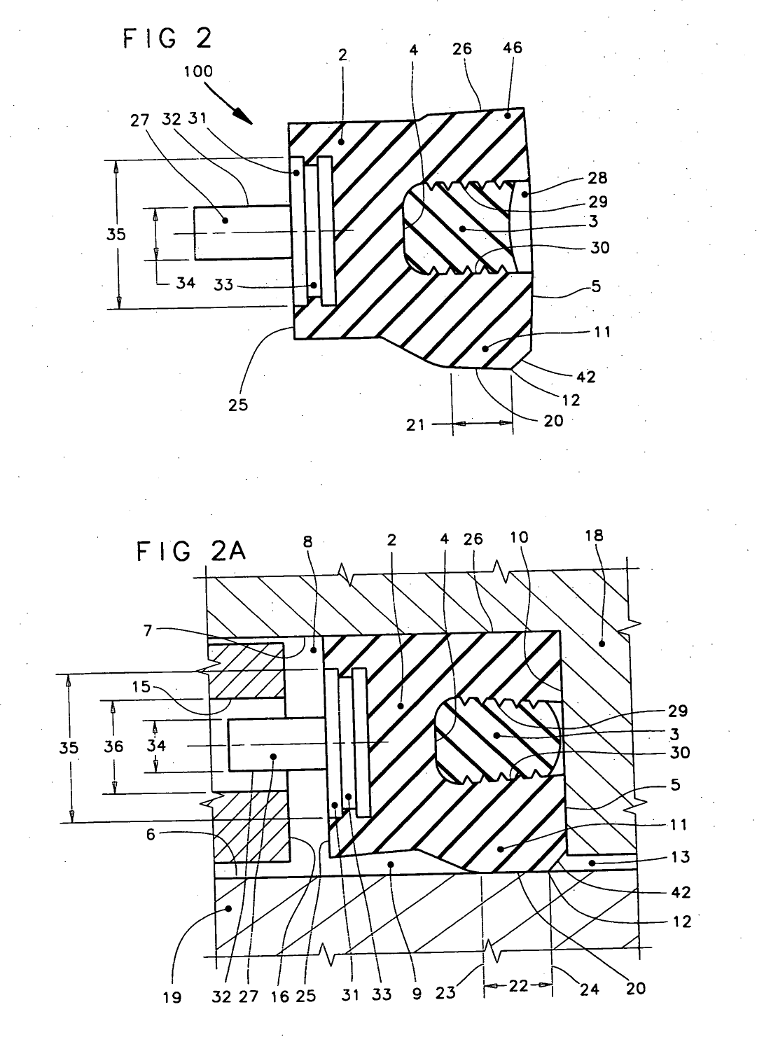

A seal according to preferred embodiments of the present invention, generally designated as 100, will now be described in detail with reference to the drawings. Although shown in fragmentary cross-section in FIGS. 2-16, the seal 100 has a generally ring-like configuration and is preferably a rotary seal. The rotary seal 100, being a generally circular entity, defines a theoretical centerline/axis (not shown), and the cross-sections of FIGS. 2-16 are longitudinal cross-sectional illustrations taken at a cutting plane that passes through that theoretical centerline; i.e., the theoretical centerline lies on the cutting plane. The circumferential direction of relative rotation is normal (perpendicular) to the plane of the cross-section, and the theoretical centerline of rotary seal 100 generally coincides with the axis of relative rotation. It is to be understood that items throughout this specification that are represented by like numbers have the same function.

Description of FIGS. 2 and 2A

The seal 100 is shown in an uninstalled condition in FIG. 2 and in an installed condition in FIG. 2A. Referring to FIG. 2A, a first machine component 18 and a second machine component 19 together typically define a portion of a chamber for locating the lubricant 9 and defining a lubricant supply. The lubricant 9 is exploited to lubricate a dynamic sealing interface between the rotary seal 100 and a relatively rotatable surface 6 during relative rotation thereof. Lubricant 9 is preferably a liquid-type lubricant such as a synthetic or natural oil, although other fluids including greases, water, and various process fluids are also suitable in some applications. The environment 13 (FIG. 2A) may be any type of fluid that rotary seal 100 may be exposed to in service, such as any type of liquid or gaseous environment including, but not limited to, a lubricating media, a process media, a drilling fluid, etc. The environment 13 may also be a vacuum.

The preferred embodiment of the rotary seal 100 is typically oriented (i.e., positioned) by a seal groove 8 of generally circular configuration that includes a lubricant side groove wall 16 and an environment-side groove wall 10 that are in generally opposed relation to one another. The provisions for orienting the seal 100 can take other specific forms without departing from the spirit or scope of the invention. If desired, lubricant side groove wall 16 and environment-side groove wall 10 can be configured to be separable for ease of maintenance and repair, but then assembled in more or less fixed location for locating the rotary seal 100, as shown in FIG. 2A.

A cavity collectively defined by the lubricant side groove wall 16, environment-side groove wall 10 and a peripheral wall 7 is typically referred to as the seal groove 8, and a cavity defined by the seal groove 8 and the relatively rotatable surface 6 is typically referred to as the seal gland.

The purposes of the preferred embodiment of the rotary seal 100 are to establish sealing engagement with the relatively rotatable surface 6, to retain the lubricant 9, to partition the lubricant 9 from the environment 13, and to exclude the environment 13 and prevent intrusion of the environment 13 into the lubricant 9.

A seal body 2 preferably incorporates a dynamic sealing lip 11 of generally circular (i.e., ring-like) form that defines a dynamic sealing surface 20 having a surface width 21 (FIG. 2) that preferably varies around the circumference of the rotary seal 100. When installed, at least a portion of the dynamic sealing surface 20 is held in contacting relation with the relatively rotatable surface 6.

Regardless of whether or not the surface width 21 varies around the circumference of rotary seal 100, the rotary seal 100 is configured such that when the dynamic sealing lip 11 is compressed against the relatively rotatable surface 6, an interfacial contact footprint is established that preferably has a variable footprint width 22 (FIG. 2A). As shown in FIG. 2A, the variable footprint width 22 has a lubricant-side footprint edge 23 that is preferably non-circular, and an environment-side footprint edge 24 that is preferably circular and substantially aligned with the possible directions of relative rotation between dynamic sealing lip 11 and relatively rotatable surface 6.

Dynamic sealing lip 11 preferably incorporates a dynamic exclusionary intersection 12 of abrupt circular form that is substantially aligned with the direction of relative rotation, and is adapted to exclude intrusion of the environment 13, in accordance with the teachings of commonly assigned U.S. Pat. No. 4,610,319. Dynamic exclusionary intersection 12 is of a configuration developing substantially no hydrodynamic wedging activity during relative rotation between dynamic sealing lip 11 and relatively rotatable surface 6. Dynamic exclusionary intersection 12 presents a scraping edge to help exclude contaminant material from the interface between dynamic sealing lip 11 and relatively rotatable surface 6 in the event of any relative movement occurring perpendicular to the direction of relative rotation between dynamic sealing lip 11 and relatively rotatable surface 6. Dynamic exclusionary intersection 12 need not be present unless abruptness and circularity are desired for more efficient environment exclusion.

Environment-side footprint edge 24 is established by compression of dynamic exclusionary intersection 12 against relatively rotatable surface 6. Due to environment-side footprint edge 24 being substantially circular and substantially aligned with the possible directions of relative rotation, it does not produce a hydrodynamic wedging action in response to relative rotation between the dynamic sealing lip 11 and the relatively rotatable surface 6, thereby facilitating exclusion of environment 13 in accordance with the teachings of commonly assigned U.S. Pat. No. 4,610,319.

The variable-width nature of the variable footprint width 22 can be established by any suitable means, including the various means described in the prior art. For example, one way to create a variable footprint width 22 is to cause the surface width 21 of the dynamic sealing lip 11 to vary around the circumference of rotary seal 100 as shown in U.S. Pat. Nos. 4,610,319 and 6,109,618. Another way is to use a variable depth seal body as shown in U.S. Pat. No. 6,685,194. Still other ways are to provide the dynamic sealing surface 20 with variable slope as shown in U.S. Pat. No. 6,685,194, or to use projections as shown in U.S. Pat. Nos. 6,036,192, 6,494,462 and 6,561,520.

During the presence of relative rotation between dynamic sealing lip 11 and relatively rotatable surface 6, the sealed interface between dynamic sealing lip 11 and relatively rotatable surface 6 becomes a dynamic sealing interface, with sliding occurring between dynamic sealing lip 11 and relatively rotatable surface 6. In the absence of relative rotation between dynamic sealing lip 11 and relatively rotatable surface 6, the sealed interface between dynamic sealing lip 11 and relatively rotatable surface 6 is a static sealing interface.

In dynamic operation, the relatively rotatable surface 6 has relative rotation with respect to dynamic sealing surface 20 of rotary seal 100 and with respect to seal groove 8. It is to be understood that the preferred embodiment of the present invention has application where either the relatively rotatable surface 6 or the seal groove 8, or both, are individually rotatable.

During relative rotation between the dynamic sealing lip 11 and the relatively rotatable surface 6, the variable width aspect of the footprint width 22 caused by the non-circular lubricant-side footprint edge 23 causes a film of the lubricant 9 to be hydrodynamically wedged into the dynamic interface between the dynamic sealing lip 11 and the relatively rotatable surface 6. This film of lubricant 9 reduces running torque compared to non-hydrodynamic seals, and allows the seal 100 to operate at much higher surface speeds and differential pressure than would otherwise be possible, with very little wear. In other words, dynamic sealing lip 11 slips or hydroplanes on a film of the lubricant 9 during periods of relative rotation between dynamic sealing lip 11 and relatively rotatable surface 6. When relative rotation stops, the hydroplaning activity stops, and a static sealing relationship is re-established between dynamic sealing lip 11 and relatively rotatable surface 6 due to the initial compression of dynamic sealing lip 11 against relatively rotatable surface 6.

As with the commonly assigned prior art patents, the generally ring-like rotary seal 100 of the present invention can be configured to run against a relatively rotatable surface 6 having either planar form or cylindrical form.

Relatively rotatable surface 6 can take the form of an externally or internally oriented, substantially cylindrical surface, as desired, with rotary seal 100 compressed radially between relatively rotatable surface 6 and peripheral wall 7 of seal groove 8. In this case the axis of relative rotation would be substantially parallel to relatively rotatable surface 6. In a radial sealing configuration, dynamic sealing lip 11 is oriented for compression in a substantially radial direction, and peripheral wall 7 may be of substantially cylindrical configuration, and lubricant side groove wall 16, environment-side groove wall 10, lubricant-side seal end 25 and environmental end 5 may, if desired, be of substantially planar configuration.

For radial sealing against a relatively rotatable surface 6 of external cylindrical form such as the outer surface of a shaft, the dynamic sealing lip 11 projects in a generally inward radial direction, and the dynamic sealing surface 20 is at the inside of the generally ring-like rotary seal 100 and oriented generally radially inward for contacting the relatively rotatable surface 6 defined by the shaft. A static sealing surface 26 is oriented generally radially outward for contacting peripheral wall 7 of seal groove 8. Seal groove 8 is defined by the housing that surrounds the shaft.

If the generally ring-like rotary seal 100 is configured for sealing against a relatively rotatable surface 6 of internal cylindrical form such as the bore of a housing, the dynamic sealing lip 11 projects in a generally outward radial direction, and the dynamic sealing surface 20 is at the outside of the generally ring-like rotary seal 100 and oriented generally radially outward for contacting the relatively rotatable surface 6 defined by the housing bore. Static sealing surface 26 is oriented generally radially inward for contacting peripheral wall 7 of seal groove 8 that is defined by the shaft within the housing bore. These possible radial sealing orientations are well known in the art, including the commonly assigned prior art patents.

If the generally ring-like rotary seal 100 is configured for sealing against a relatively rotatable surface 6 of generally planar form such as the shoulder of a machine member, the dynamic sealing surface 20 is at an axial end of the generally ring-like rotary seal 100, and the dynamic sealing lip 11 projects in a generally axially oriented direction. The rotary seal 100 is compressed axially between relatively rotatable surface 6 and peripheral wall 7 of seal groove 8 in a “face-sealing” arrangement, in which case the axis of relative rotation would be substantially perpendicular to relatively rotatable surface 6. In an axial (face) sealing configuration, dynamic sealing lip 11 is oriented for compression in a substantially axial direction, peripheral wall 7 of seal groove 8 may be of substantially planar configuration, and lubricant side groove wall 16, environment-side groove wall 10, lubricant-side seal end 25 and environmental end 5 may, if desired, be of substantially cylindrical configuration. In a face-sealing orientation, the dynamic sealing lip 11 can be configured for the lubricant 9 to be located either inboard or outboard of the dynamic sealing lip 11. These possible face-sealing orientations are well known in the art, including the commonly assigned prior art patents.

It is also well known in the prior art that large diameter elastomeric seals are torsionally limp, and therefore, the cross-section of large diameter seals can be twisted so that dynamic sealing lip 11 can be oriented in any direction at the time of installation. The relative torsional stiffness of small diameter seals is much higher, and therefore, the dynamic sealing lip 11 for small seals should be manufactured in the desired radial or axial sealing configuration as may be required by a particular sealing application. In summary, the seal 100 according to the preferred embodiment of the present invention can be used as a face seal or a radial seal by configuring (by twisting or by manufacture) the dynamic sealing lip 11 to be located at either the inside diameter, the outside diameter, or the end of the seal 100, while maintaining the advantages of the invention that are disclosed herein.

Peripheral wall 7 can be substantially parallel to relatively rotatable surface 6 as shown, or could be angulated with respect to relatively rotatable surface 6 as shown by the prior art of commonly assigned U.S. Pat. No. 5,230,520.

Although the lubricant-side seal end 25 is shown in FIG. 2A as having a clearance relationship with lubricant side groove wall 16, the features of the present invention are also suitable for seals built to withstand simultaneous contact with both the lubricant side groove wall 16 and the environment-side groove wall 10 in accordance with the teachings of commonly assigned U.S. Pat. Nos. 5,873,576; 6,036,192 and 6,315,302.

Relatively rotatable surface 6 of second machine component 19 and peripheral wall 7 of first machine component 18 are in spaced relation to each other. For a compression-type seal such as shown in FIGS. 2 and 2A, the spacing of relatively rotatable surface 6 and peripheral wall 7 is sized to hold rotary seal 100 in compression. In the same manner as any conventional interference-type seal, such as an O-ring or an O-ring energized lip seal, the compression of rotary seal 100 establishes a sealing interface between a static sealing surface 26 of rotary seal 100 and peripheral wall 7 of first machine component 18. The compression also establishes the sealed interface between dynamic sealing lip 11 and relatively rotatable surface 6.

The main components of the preferred embodiment of the rotary seal 100 are a seal body 2 having a generally C-shaped configuration, an energizer 3, and an anti-rotation pin 27. The seal body 2, energizer 3 and anti-rotation pin 27 are preferably an integral unit. The energizer 3 is located by an annular recess 4 of the seal body 2.

Preferably, the seal body 2 is manufactured from a flexible polymeric sealing material such as an elastomer or a plastic sealing material. The anti-rotation pin 27 is preferably manufactured from a substantially rigid material such as metal or a relatively hard plastic. The energizer 3 of FIGS. 2-7, 12 and 12A is preferably a resilient material having a modulus of elasticity that is lower than the modulus of elasticity of the dynamic sealing lip 11 in order to manage interfacial contact pressure to optimum levels for lubrication and low torque as taught by commonly assigned U.S. Pat. No. 5,738,358. For example, a 30-80 durometer Shore A elastomer can be used to form the energizer 3, and a sealing material having a hardness greater than 80 durometer Shore A can be used to form the dynamic sealing lip 11 (such as an elastomer or a carbon-graphite reinforced PTFE plastic). Thus, the extrusion resistance at the dynamic sealing lip 11 is controlled by its modulus of elasticity, but the interfacial contact pressure between the dynamic sealing lip 11 and the relatively rotatable surface 6 is controlled largely by the modulus of elasticity of the energizer 3.

Preferably, the energizer 3 is integrally connected to the seal body 2 during the seal manufacturing process. Two preferred manufacturing processes are possible. If the energizer 3 is a castable material such as silicone, it can be cast into place after the seal body 2 is manufactured. If the energizer 3 is a moldable material, it is molded into place after the seal body 2 is manufactured.

The volume of annular recess 4 decreases when the seal 100 is installed in a compressed condition. Preferably, when the rotary seal 100 is installed in compression between relatively rotatable surface 6 and peripheral wall 7 of seal groove 8, the volume of the energizer 3 is less than or equal to (i.e., does not exceed) the volume of the annular recess 4, in order to avoid the above-described amplification problem associated with the prior art seals.

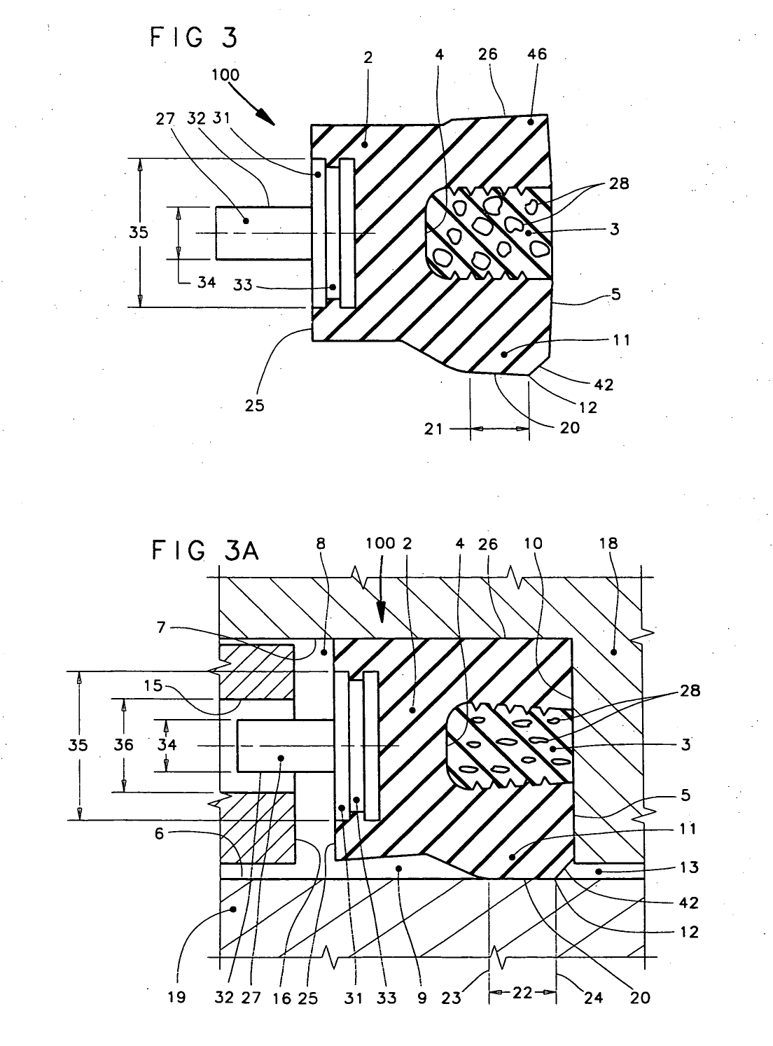

The above-described volume relationship can be established in several ways. As shown in FIG. 2, when the rotary seal 100 is in the relaxed, uncompressed, uninstalled state, a void space 28 can be incorporated such that the energizer 3 is recessed below the environmental end 5 to the extent necessary to prevent the volume of energizer 3 from exceeding the compressed volume of the annular recess 4. Preferably, this also prevents the energizer 3 from bulging beyond the environmental end 5 of the seal body 2 when installed. Another way, described in conjunction with FIGS. 3 and 3A, is to incorporate a void space 28 in the form of gas bubbles within the energizer 3, to reduce the actual material volume of the energizer 3.

By preventing the amplification problem associated with the prior art seals, the interfacial contact pressure between the dynamic sealing lip 11 and the relatively rotatable surface 6 is kept in a lower range (compared to the prior art) where effective hydrodynamic lubrication and low running torque can be achieved. This allows significantly higher surface speeds, compared to the prior art, without overheating and loss of lubrication.

The contact pressure at the interface between the dynamic sealing lip 11 and the mating relatively rotatable surface 6 is one of several important factors controlling seal-generated heat because it influences hydrodynamic film thickness, which in turn influences the shear rate of the lubricant film and the amount of asperity contact, if any, between dynamic sealing lip 11 and relatively rotatable surface 6.

Aside from the relative modulus attributes discussed above, a desirable material attribute for forming the energizer 3 is good compression set resistance and chemical resistance, and desirable attributes for forming the seal body 2 are good dynamic wear resistance, compression set resistance and chemical resistance. Unfortunately, not all materials suitable for forming the energizer 3 achieve a good bond when formed to the annular recess 4 of the seal body 2. Ideally, the bond should be stronger than either of the two materials so that they cannot “de-bond” or separate during the stress of seal compression and dynamic operation, however, this desirable level of bond strength isn't always achievable. For example, the chemically resistant nature of the two materials, or the chemical differences between the materials, can make them less capable of forming a bond that is stronger than either material. As another example, if the seal body 2 is molded from an elastomer, the surface of the annular recess 4 tends to have skin-like surface characteristics that interfere with achieving a bond that is stronger than either material. To facilitate improved bonding between the energizer 3 and the seal body 2, the annular recess 4 of the seal body 2 preferably incorporates retaining ridges 29 and retaining depressions 30 that are preferably generally circular in form as shown in FIGS. 2 and 2A. The retaining ridges 29 and retaining depressions 30 provide a mechanical interlock at the bond line between the seal body 2 and the energizer 3 that relieves compression-induced shear stress at the bond line, and serves to prevent bond failure and loss of the energizer 3. The retaining ridges 29 and retaining depressions 30 also provide increased interface contact area between the energizer 3 and the seal body 2, which helps to prevent failure of any bond present at that interface. The retaining ridges 29 and retaining depressions 30 can be formed by any suitable forming process, such as molding, machining or abrading.

Still referring to FIGS. 2 and 2A, the anti-rotation pin 27 includes an enlarged head 31 and a shank 32. The enlarged head 31 preferably includes a retaining groove 33 that is interlocked with the seal body 2, preferably at the time the seal body 2 is formed.

In addition to the retaining groove 33, the enlarged head 31 of the anti-rotation pin 27 can be connected to the seal body 2 by bonding. For example, the enlarged head 31 can be coated with a bonding agent, and the seal body 2 can then be formed around the enlarged head 31 by a conventional molding process such as compression, transfer or injection molding. The seal body 2 becomes bonded to the enlarged head 31 of the anti-rotation pin 27 during the molding process.

In regards to the anti-rotation pin 27, the shank dimension 34 of the shank 32 is preferably smaller than the head dimension 35 of the enlarged head 31. When the rotary seal 100 is installed, the shank 32 engages a pocket 15 formed in the lubricant side groove wall 16. The lubricant side groove wall 16 is preferably inhibited or prevented from relative rotation with the peripheral wall 7 by any suitable means (not shown) such as mechanical interlocking, spring loading, bolting or integral construction. Such means for preventing rotation of the lubricant side groove wall 16 relative to the peripheral wall 7 are known in the art of seals in general and hydrodynamic rotary seals in particular, and are not considered part of the present invention, and therefore are not illustrated. The pocket 15 has a pocket dimension 36 greater than shank dimension 34 to receive the shank 32. The engagement between the pocket 15 and the shank 32 prevents the rotary seal 100 from rotationally slipping within the seal groove 8, and thereby prevents abrasion of the seal body 2 and/or the energizer 3 of rotary seal 100 that could otherwise be caused by such rotational slippage.

Preferably, head dimension 35 of the enlarged head 31 is greater than the pocket dimension 36 of pocket 15. As a result, in the event that the pressure of the environment 13 is greater than the pressure of the lubricant 9, the overlap of the enlarged head 31 over the pocket 15 prevents the pressure of the environment 13 from locally deforming the seal body 2 into the pocket 15, and thereby helps to keep the dynamic exclusionary intersection 12 in generally circular contact with the relatively rotatable surface 6, and prolongs the life of the rotary seal 100 by preventing the skew-induced abrasive wear described above in conjunction with the prior art.

The dynamic exclusionary intersection 12 of the seal body 2 is constructed according to the teachings of commonly assigned U.S. Pat. No. 4,610,319 for excluding the environment 13. In order to help to establish and control a desirable level of interfacial contact pressure between the dynamic sealing surface 20 and the relatively rotatable surface 6, the present invention preferably incorporates a non-planar flexible heel geometry 42 in accordance with the teachings of commonly assigned U.S. Pat. No. 5,738,358.

The seal body 2 preferably incorporates a projecting static lip 46, in accordance with the teachings of commonly assigned U.S. Pat. Nos. 5,230,520; 5,738,358; 6,685,194; and 6,767,016, to provide a degree of compressive symmetry that minimizes the potential for twisting of rotary seal 100 that would otherwise occur during installation, and for management of interfacial contact pressure in the interface between the seal body 2 and the relatively rotatable surface 6 to achieve desirable lubrication and exclusion characteristics during relative rotation. As shown in FIG. 2, in the uncompressed state, it is preferable that the dynamic sealing surface 20 is tapered, in accordance with the teachings of commonly assigned U.S. Pat. Nos. 6,685,194 and 6,767,016, for management of interfacial contact pressure in the interface between the seal body 2 and the relatively rotatable surface 6.

Preferably, the projecting static lip 46 is tapered as shown in FIG. 2. The taper of projecting static lip 46 and/or static sealing surface 26 also helps to achieve desirable exclusion characteristics during relative rotation by providing additional seal compression near environmental end 5.

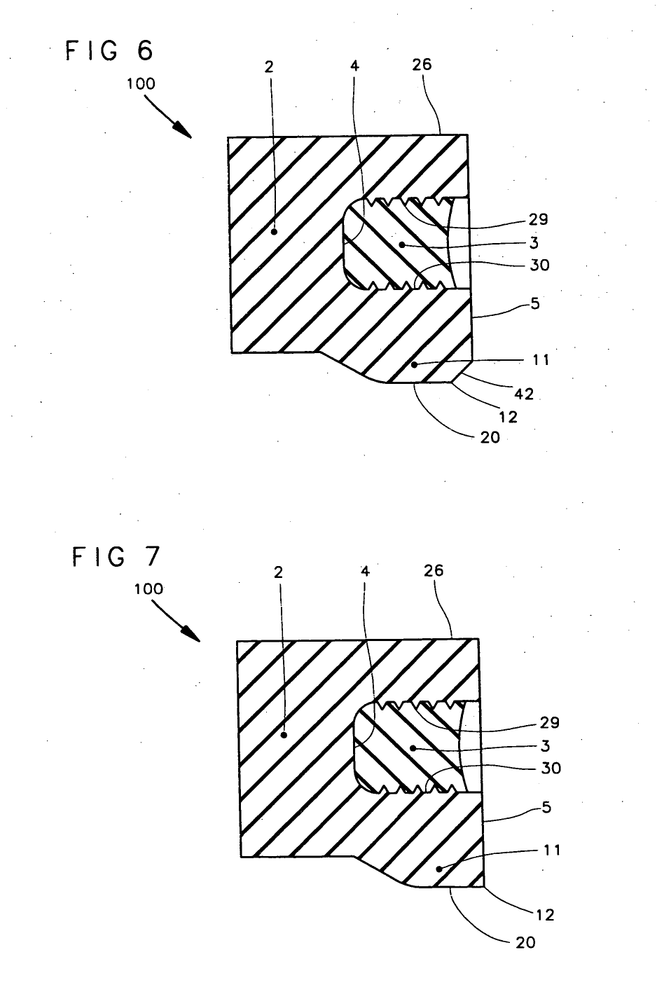

The geometry of projecting static lip 46 can take other forms without departing from the spirit or scope of the present invention; for example, any of the static lip forms shown in commonly assigned U.S. Pat. Nos. 5,230,520 and 6,767,016 could be employed if desired. FIGS. 5, 9 and 10 herein illustrate alternate geometries of projecting static lip 46. The embodiments illustrated herein that incorporate a projecting static lip 46 can also be simplified, if desired, by elimination of the projecting static lip 46—for example, as shown in FIGS. 6, 7 and 11.

Description of FIGS. 3 and 3A

In the fragmentary cross-section of FIG. 3, an embodiment of the generally ring-like rotary seal 100 of the present invention is shown in the uninstalled condition. The same rotary seal 100 is shown in the installed condition in the fragmentary cross-section of FIG. 3A.

The seal body 2 of FIG. 3 (and all of the seals of FIGS. 2-16) preferably incorporates a dynamic sealing lip 11 of generally circular (i.e., ring-like) form that defines a dynamic sealing surface 20 having a surface width 21 that preferably varies around the circumference of rotary seal 100. The seal body 2 of FIG. 3 preferably also incorporates a projecting static lip 46.

Dynamic sealing lip 11, dynamic exclusionary intersection 12, dynamic sealing surface 20, lubricant-side seal end 25, static sealing surface 26, anti-rotation pin 27, enlarged head 31, shank 32, retaining groove 33, shank dimension 34, head dimension 35 and non-planar flexible heel geometry 42 are labeled in FIGS. 3 and 3A for orientation purposes, and are identical to the like-numbered items shown in FIGS. 2 and 2A. Additionally, environment 13, environment-side groove wall 10, pocket 15, lubricant side groove wall 16, first machine component 18, second machine component 19, variable footprint width 22, lubricant-side footprint edge 23, environrment-side footprint edge 24 and pocket dimension 36 are labeled in FIG. 3A for orientation purposes, and are identical to the like-numbered items shown in FIG. 2A.

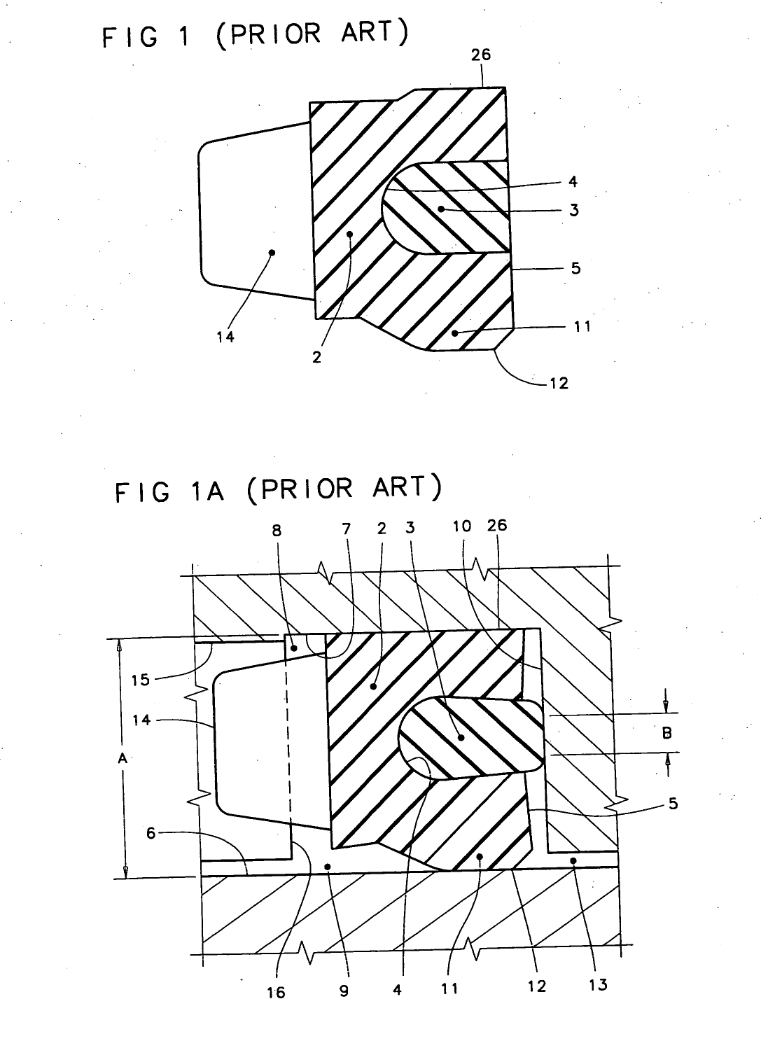

The rotary seal 100 of FIGS. 3 and 3A is identical to that of FIGS. 2 and 2A with the exception of the configuration of the energizer 3 and the void space 28. In FIGS. 3 and 3A, the void space 28 is in the form of gas bubbles within the energizer 3, which reduces the actual material volume of the energizer 3. As shown in FIG. 3A, when the rotary seal 100 is compressed between the relatively rotatable surface 6 and the peripheral wall 7 of seal groove 8, the gas bubbles are compressed. Thus, the energizer 3 achieves a key attribute of the present invention—in the compressed state of the rotary seal 100, the actual volume of the material forming the energizer 3 is less than the volume of the annular recess 4 due to the internal gas bubbles comprising the void space 28, and therefore prevents the interfacial contact pressure amplification associated with the prior art that was described above in conjunction with FIGS. 1 and 1A.

Preferably, the internal bubbles or cavities are of the closed cell variety and contain gas so that compression of the gas at the time of seal installation adds a degree of permanent compression set resistance to the energizer 3. Resilient seal material is subject to compression set over time, reducing sealing effectiveness. Compressed gas is not subject to compression set over time per se. Therefore, if the void space 28 of the embodiment of FIGS. 3 and 3A is comprised of gas filled closed cell cavities, the embodiment of FIGS. 3 and 3A is more compression set resistant than the embodiment of FIGS. 2 and 2A.

Such closed cells can be created in castable silicone by foaming the uncured silicone by the simple expedient of injecting air bubbles, or by otherwise entraining air within the uncured silicone. For example, by stirring air into the uncured silicone. If a relatively thick viscosity castable silicone is used, the bubble cavities remain in the silicone, rather than rising to the surface, during the curing process—particularly if the cure is accelerated with heat.

Although in the absence of pressure within the lubricant 9, the end of the energizer 3 may still bulge past the environmental end 5 of the seal body 2 due to compression of rotary seal 100, the energizer 3 bulges less than if the bubbles were absent. Once the pressure of the lubricant 9 is applied, the bubbles forming the void space 28 collapse more to prevent the prior art interfacial contact pressure amplification problem that was described above in conjunction with FIGS. 1 and 1A.

The inventors and their associates have manufactured and tested seals having the energizer 3 made substantially flush with the end of the seal, but including void space 28 comprised of gas-filled bubbles to control the volume of the energizer 3 to be less than the compressed volume of the annular recess 4. In these tests, the air-filled cavities prevented the interfacial contact pressure amplification associated with the prior art and described above, and allowed the seals 100 to operate with low running torque. This is true even though the face of the energizer 3 may bulge past the environmental end 5 of the seal body 2 when installed, because the bubbles adjust the volume of the energizer 3 to be less than the compressed volume of the annular recess 4.

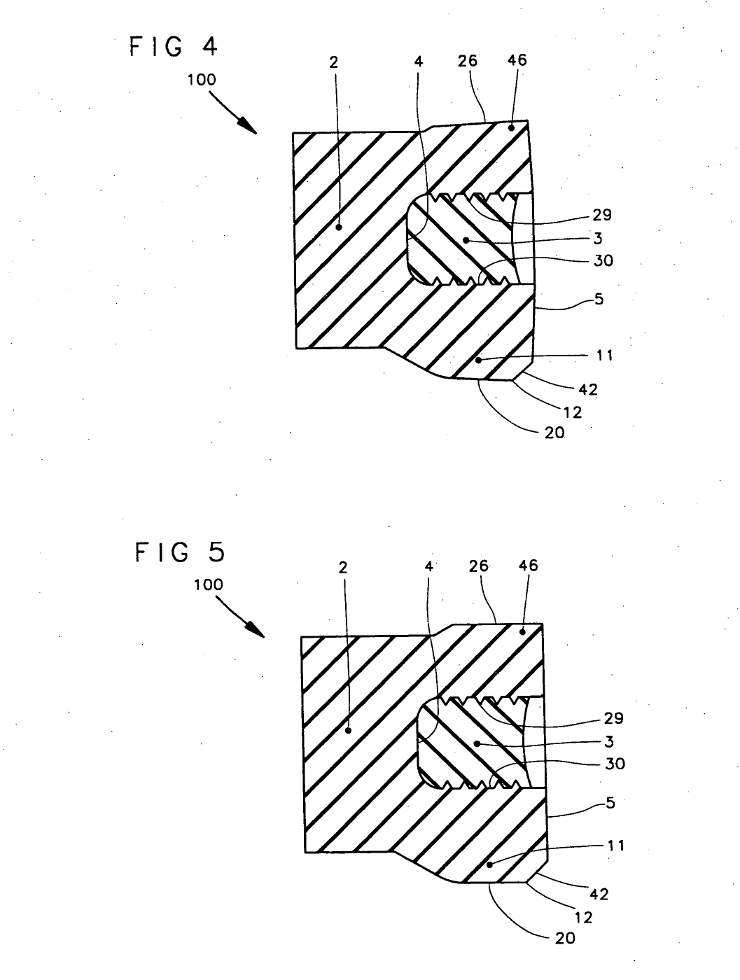

Although not all of the seal embodiments are illustrated in an installed condition, the seal embodiments of FIGS. 4-16 are also adapted to be received within a seal groove 8 and compressed between a relatively rotatable surface 6 and a peripheral wall 7 of a seal groove 8 as described above in conjunction with FIGS. 2-3A.

Description of FIGS. 4-7

Simplified embodiments of the present invention are possible, wherein one or more features are omitted. FIGS. 4-7 show that the rotary seal 100 of the present invention can be simplified, if desired, by eliminating the anti-rotation pin 27 shown in FIGS. 2-3A. The rotary seal 100 of FIGS. 4-7 includes the energizer 3 in which the compressed volume of the energizer 3 is less than the compressed volume of the annular recess 4 to prevent the interfacial contact pressure amplification of the prior art energizer. If desired, the generally C-shaped cross-sectional configuration of the seal body 2, the retaining ridges 29 and retaining depressions 30 of the annular recess 4, the dynamic sealing lip 11, and the dynamic exclusionary intersection 12 may be retained.

In FIG. 4, the tapering nature of the dynamic sealing surface 20 and static sealing surface 26 is retained. As shown in FIG. 4, if the static sealing surface 26 and the dynamic sealing surface 20 are angled with respect to one another, the surfaces forming the environmental end 5 of the seal body 2 should be non-parallel so that when compressed, they become substantially parallel and in substantial conformance with the shape of the environment-side groove wall 10.

It can be appreciated that as a simplification, as shown in FIG. 5, the static sealing surface 26 and the dynamic sealing surface 20 need not be sloped as shown in FIGS. 2, 3 and 4. In FIG. 5, the static sealing surface 26 and the dynamic sealing surface 20 are substantially parallel, while in FIGS. 2, 3 and 4 the static sealing surface 26 and the dynamic sealing surface 20 are angled with respect to one another in accordance with the teachings of commonly assigned U.S. Pat. Nos. 6,685,194 and 6,767,016.

It can also be appreciated that, as a simplification, the projecting static lip 46 shown in FIGS. 2, 3, 4 and 5 can be eliminated altogether and the static sealing surface 26 can be established simply by a peripheral surface of the seal body 2 that is in generally opposed relationship to the dynamic sealing lip 11, as shown in FIGS. 6 and 7. In FIG. 6, a non-planar flexible heel geometry 42 is interposed between dynamic sealing surface 20 and environmental end 5.

The seal of FIG. 7 is further simplified compared to FIG. 6, in that the non-planar flexible heel geometry 42 of FIGS. 4-6 has been eliminated, and the dynamic exclusionary intersection 12 is defined at the intersection between environmental end 5 and dynamic sealing surface 20.

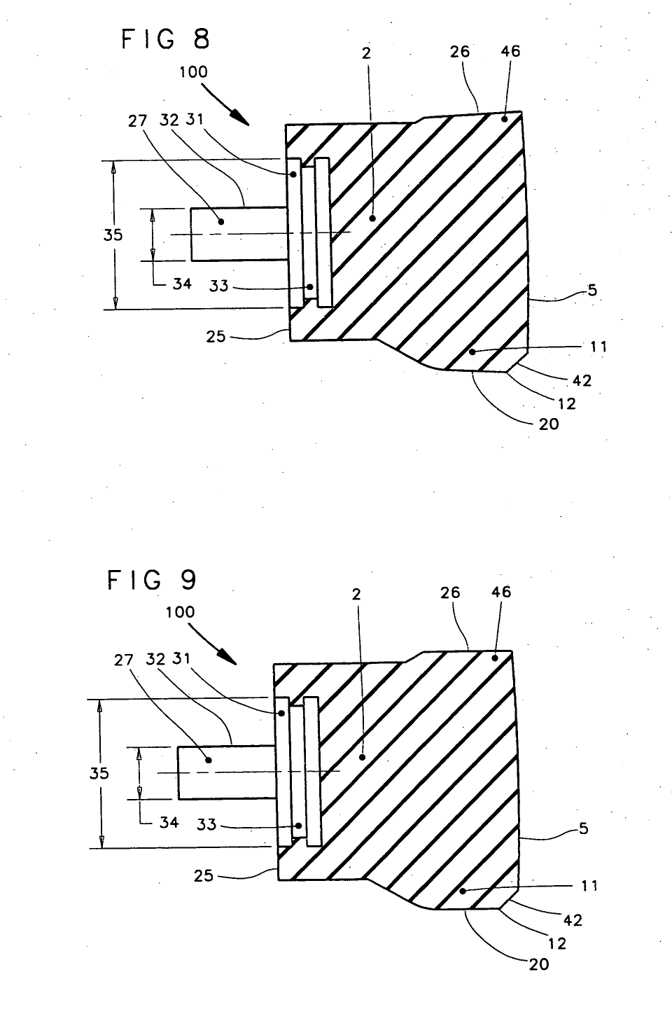

Description of FIGS. 8-11

In the rotary seal 100 of FIGS. 8-11, the energizer 3 and the annular recess 4 of FIGS. 2-7 have been eliminated as a simplification, and the seal is a solid (ungrooved) compression-type seal with a monolithic, one piece seal body 2, wherein the dynamic sealing lip 11 and static sealing surface 26 are in generally opposed relation, and in FIGS. 8-10 the static sealing surface 26 is defined by a projecting static lip 46. The unique geometry of anti-rotation pin 27 is retained at the lubricant-side seal end 25. The shank dimension 34 of the shank 32 is preferably smaller than the head dimension 35 of the enlarged head 31. The enlarged head 31 preferably includes a retaining groove 33 that is interlocked with the seal body 2, preferably at the time the seal body 2 is formed.

It is preferred that the simplified seal body 2 of FIGS. 8-11 be formed from one or more resilient materials having a nominal hardness in the range of from about 70 to about 97 Durometer Shore A. Compared to the prior art seals of single material construction, the seals of FIGS. 8-11 are prevented from slipping circumferentially within the seal groove, eliminating wear to the static sealing surface 26 and the mating countersurface of the seal groove.

In FIG. 8 the static sealing surface 26 is sloped. As a further simplification, the static sealing surface 26 is not sloped in FIG. 9. The sloped configuration of static sealing surface 26 in FIG. 8 increases compression and alters interfacial contact pressure distribution (compared to the seal of FIG. 9) in low differential pressure applications, including low reversing differential pressures, to improve exclusion of the environment. In FIG. 8, the tapered (angled with respect to one another) nature of static sealing-surface 26, the dynamic sealing surface 20 and non-planar flexible heel geometry 42 are retained.

The seal 100 of FIG. 9 is further simplified in that the static sealing surface 26 and dynamic sealing surface 20 are substantially parallel, while in FIG. 8 the static sealing surface 26 and the dynamic sealing surface 20 are angled with respect to one another. In the simplified embodiments of FIGS. 8 and 9, the environmental end 5 may be generally convex, as shown, if desired, and the dynamic exclusionary intersection 12 retained.

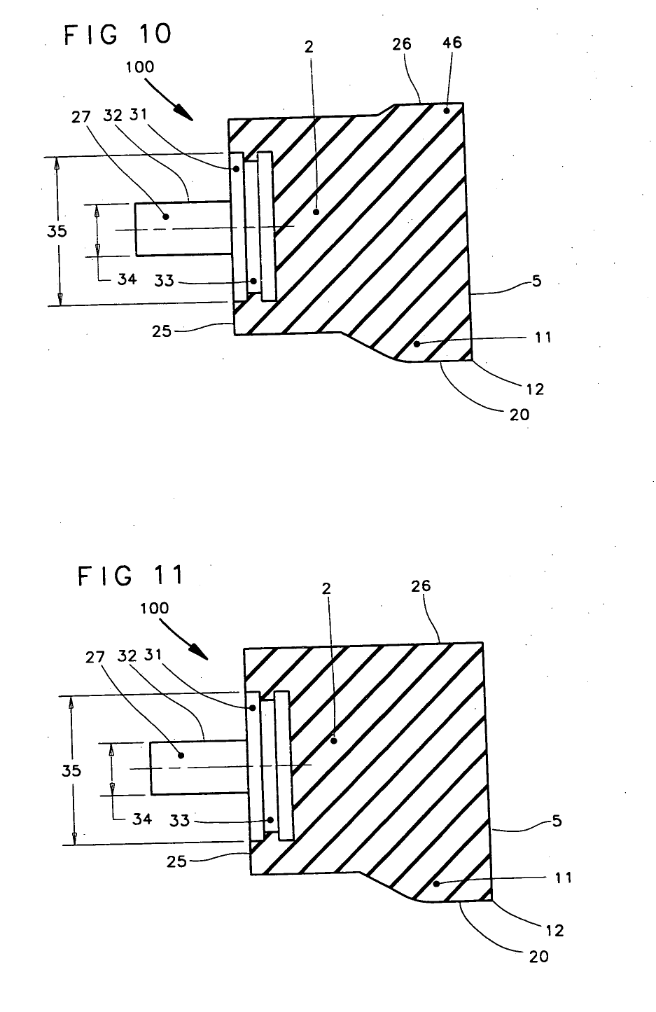

The seals 100 of FIGS. 10 and 11 are further simplified compared to the seals of FIGS. 8 and 9, in that the non-planar flexible heel geometry 42 (FIGS. 8 and 9) has been eliminated, and the dynamic exclusionary intersection 12 is defined at the intersection between environmental end 5 and dynamic sealing surface 20. As with FIGS. 8 and 9, the projecting static lip 46 in the embodiment of FIG. 10 is in generally opposed relation to the dynamic sealing lip 11.

The seal 100 of FIG. 11 is a further simplification wherein the projecting static lip 46 of FIGS. 8-10 has been eliminated, and the static sealing surface 26 is defined by a non-projecting peripheral surface of seal body 2. In the simplified embodiments of FIGS. 10 and 11, the environmental end 5 may be substantially flat, as shown, if desired.

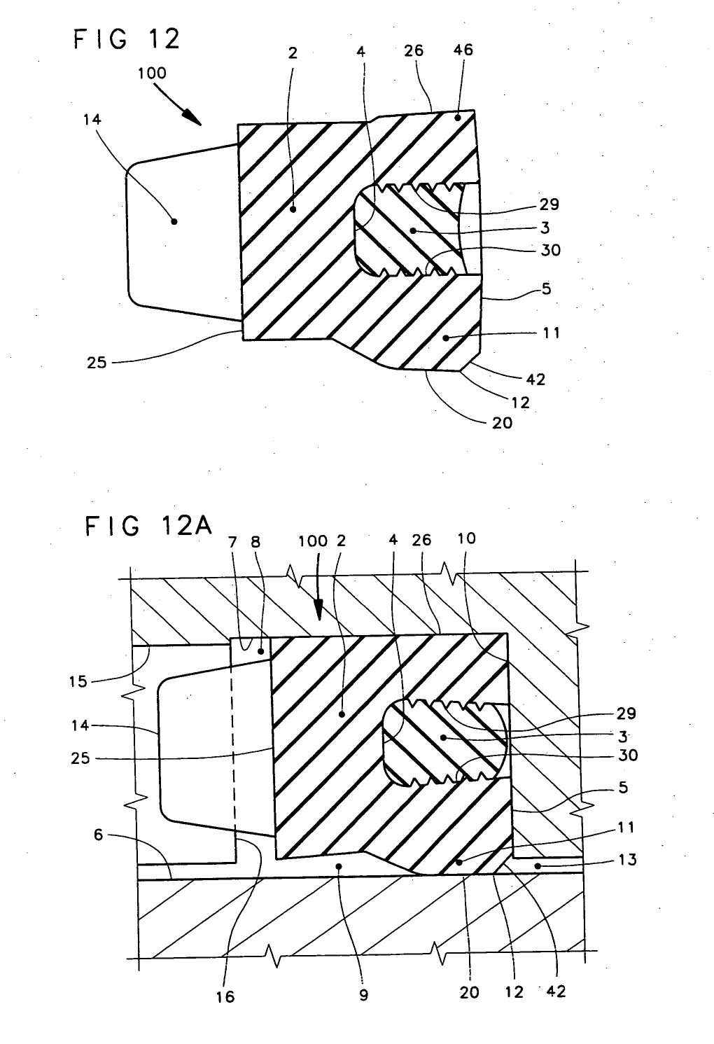

Description of FIGS. 12 and 12A

Not all seals are subjected to reversing differential pressure conditions, although prevention of slippage within the seal groove is still desirable with such seals to prevent damage to the seal, and particularly to prevent damage to the energizer 3. The energizer, which may be made from a material such as silicone that has relatively poor abrasion resistance, may be damaged if exposed to circumferential slippage with respect to the environment-side groove wall 10. FIGS. 12 and 12A show that, as an alternate embodiment, a rotary seal 100 can incorporate a seal body 2 with an annular recess 4 having retaining ridges 29 and depressions 30 to retain the energizer 3, and may also, if desired, incorporate one or more of an anti-rotation projection 14. Preferably, the anti-rotation projection 14 projects from the lubricant-side seal end 25 and is integral with, and made from the same material as, the seal body 2. Preferably, the energizer 3 has less volume than the annular recess 4 in the compressed condition. As with the prior art, the anti-rotation projection 14 engages a pocket 15 in the lubricant side groove wall 16 to prevent the rotary seal 100 from slipping circumferentially within the seal groove 8. As with the prior art, the rotary seal 100 is installed in compression between a peripheral wall 7 of seal groove 8 and a relatively rotatable surface 6 to retain a lubricant 9 and to exclude an environment 13 as shown in FIG. 12A. The static sealing surface 26, which is preferably defined by a projecting static lip 46 of tapered configuration, establishes a sealed relationship with the seal groove 8 and the dynamic sealing surface 20 of the dynamic sealing lip 11 establishes a sealed relationship with the relatively rotatable surface 6. Environmental end 5, dynamic sealing lip 11, dynamic exclusionary intersection 12 and non-planar flexible heel geometry 42 are labeled for orientation purposes.

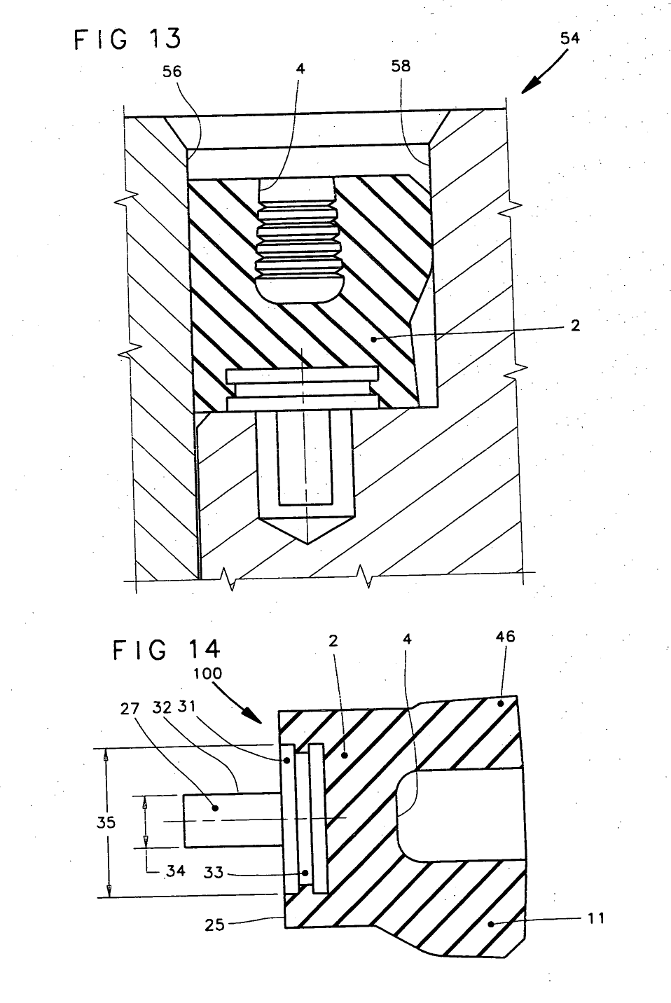

Description of FIG. 13

In FIG. 13, a filling fixture shown generally at 54 is being used to hold the seal body 2 in a compressed or partially compressed condition to control the volume of the annular recess 4. The seal body 2 is compressed between a first fixture surface 56 and a second fixture surface 58. The castable material for forming the energizer is inserted into the annular recess 4 while the seal body 2 is thus compressed. This method of filling prevents the energizer from exceeding the compressed volume of the annular recess 4, and thereby prevents the pressure amplification associated with the prior art, and described above in conjunction with FIGS. 1 and 1A.

During filling, the castable material is simply filled approximately to the top of the annular recess 4, then taken out of the filling fixture to cure so that the seal body 2 is in the relaxed state during the cure process. Due to shrinkage of the silicone during curing, the end of the energizer 3 (not shown in FIG. 13) typically assumes a concave cross-sectional shape when cured; for example, see FIG. 2. By keeping the energizer 3 bonded to the seal body 2 through the use of retaining ridges 29 and depressions 30, the initially concave end shape of the energizer 3 becomes generally more flattened when compressed to low values, and inverts and becomes convex when compressed to higher values; for example, see FIGS. 2 and 2A. If the retaining ridges 29 and depressions 30 are not employed and as a result the bond fails, the concave cross-sectional end shape returns, and the edges may project beyond the environmental end 5 when the seal body 2 is compressed, which is undesirable.

Description of FIG. 14

Although the seal embodiments disclosed heretofore in FIGS. 2-13 are interference-type compression seals that incorporate a seal body 2 made from one material and an energizer 3 made from another material, such is not intended to limit the present invention in any manner whatsoever. It is intended that the anti-rotation pin 27 of the present invention may be adapted to various types of rotary seals, and may incorporate one or more seal materials or other components without departing from the spirit or scope of the invention.

In FIG. 14, the energizer 3, illustrated in FIGS. 2-7, 12 and 12A, has been eliminated as a simplification, leaving a void in the form of an annular recess 4 where the energizer would otherwise be. The resulting seal 100 is of the flexing-lip type as taught by commonly assigned U.S. Pat. No. 5,678,829. Annular recess 4 defines dynamic sealing lip 11 and projecting static lip 46 to be of the flexing lip variety. This simplification is more appropriate in applications where it is desirable to have very low interfacial contact pressure to achieve the lowest possible torque, but where exclusion of environmental abrasives is not an important concern.

The unique geometry of anti-rotation pin 27 is retained at the lubricant-side seal end 25. Preferably, the shank dimension 34 of the shank 32 is smaller than the head dimension 35 of the enlarged head 31. The enlarged head 31 preferably includes a retaining groove 33 that is interlocked with the seal body 2, preferably at the time the seal body 2 is formed.

The flexibility of dynamic sealing lip 11 relieves some of the contact pressure between the dynamic sealing lip 11 and the relatively rotatable surface 6 (See FIG. 1) that would otherwise occur if the seal were of the direct compression type, thereby helping to assure low torque. The flexible lip construction permits the use of relatively high modulus materials that would otherwise be unsuitable for use in a solid (ungrooved) monolithic seal due to the high interfacial contact pressure that would result with a solid seal.

The simplified rotary seal 100 of FIG. 14 may be composed of any suitable sealing material, including elastomeric or rubber-like materials and various polymeric materials, however, it is preferred that the seal body 2 be made from a reinforced material, such as a multiple ply fabric reinforced elastomer.

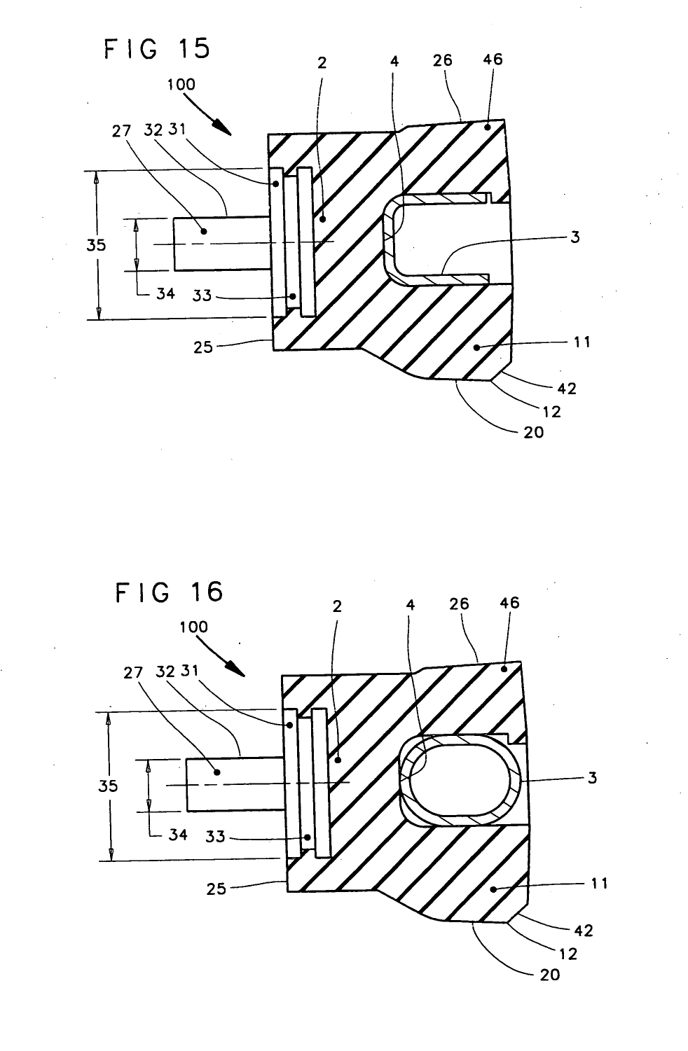

Description of FIGS. 15-16

FIGS. 15 and 16 each show a rotary seal 100 in the uncompressed state, representing alternative embodiments of the present invention, wherein an energizer 3 located within annular recess 4 is provided to spring-load the dynamic sealing lip 11 against a relatively rotatable surface 6 (not shown). The unique geometry of anti-rotation pin 27 is retained at the lubricant-side seal end 25. Preferably, the shank dimension 34 of the shank 32 is smaller than the head dimension 35 of the enlarged head 31. The enlarged head 31 preferably includes a retaining groove 33 that is interlocked with the seal body 2, preferably at the time the seal body 2 is formed. Dynamic sealing surface 20 is in generally opposed relation to static sealing surface 26. If desired, static sealing surface 26 can be defined as a surface of a projecting static lip 46. The rotary seal 100 may also incorporate dynamic exclusionary intersection 12 and non-planar flexible heel geometry 42, if desired.

In FIGS. 2-7, 12 and 12A, rotary seal 100 is illustrated as a compression-type seal, but the basic concept can be converted to a flexing cantilever lip type seal by substitution of an energizer 3 taking the form of a mechanical spring, as shown by FIGS. 15 and 16 herein.

In FIGS. 15 and 16, the dynamic sealing lip 11 is made from sealing material having a modulus of elasticity, and the energizer 3 is a spring having a modulus of elasticity that is greater than the material used to form the seal body 2. For example, the seal body 2 could be made from an elastomer or plastic, and the spring comprising the energizer 3 could be made from a metal. Springs are highly desirable for use as energizers in hydrodynamic seals because their high modulus of elasticity allows them to cause the dynamic sealing lip 11 to follow relatively high levels of runout, and because they are more resistant to high temperature compression set compared to many elastomeric energizers. In FIG. 15, the energizer 3 is a cantilever spring, and the energizer 3 is a canted coil spring in FIG. 16.

In view of the foregoing it is evident that the present invention is one that is well adapted to attain all of the objects and features hereinabove set forth, together with other objects and features which are inherent in the apparatus disclosed herein.

Even though several specific hydrodynamic rotary seal and seal gland geometries are disclosed in detail herein, many other geometrical variations employing the basic principles and teachings of this invention are possible.

The foregoing disclosure and description of the invention are illustrative and explanatory thereof, and various changes in the size, shape and materials, as well as in the details of the illustrated construction, may be made without departing from the spirit of the invention. The present embodiments are, therefore, to be considered as merely illustrative and not restrictive, the scope of the invention being indicated by the claims rather than the foregoing description, and all changes which come within the meaning and range of equivalence of the claims are therefore intended to be embraced therein.

We claim:

1. A sealing assembly for partitioning a first fluid from a second fluid, the sealing assembly comprising:
a first machine component defining a seal groove adjoined to a pocket recess;
a second machine component having a relatively rotatable surface; and
a rotary seal in compressed, sealing engagement with said first and second machine components, said rotary seal comprising:
a seal body of generally ring-like construction, said seal body having a predetermined modulus of elasticity and defining a dynamic sealing lip having a dynamic sealing surface, said seal body having an annular recess defining a plurality of retaining ridges and retaining depressions, said annular recess having a first volume in an uninstalled condition and a second volume when said rotary seal is in said compressed, sealing engagement with said first and second machine components;
an energizer element positioned in said annular recess and engaging said plurality of retaining ridges and depressions in said annular recess, said energizer element having a modulus of elasticity that is different than said predetermined modulus of elasticity of said seal body, wherein when said rotary seal is in said compressed, sealing engagement with said first and second machine components said energizer element has a volume that is no greater than said second volume of said annular recess; and
an anti-rotation projection engaged to said seal body, said anti-rotation projection extending from said seal body into said pocket recess of said first machine component.

2. The sealing assembly of claim 1, wherein said modulus of elasticity of said energizer element is lower than said predetermined modulus of elasticity of said seal body.

3. The sealing assembly of claim 1, wherein said energizer element is made of a castable material.

4. The sealing assembly of claim 3, wherein said energizer element is cast in said seal body annular recess to form a mechanical interlock with said plurality of retaining ridges and depressions in said annular recess.

5. The sealing assembly of claim 1, wherein said energizer element remains entirely within said annular recess when said rotary seal is in said compressed, sealing engagement with said first and second machine components.

6. The sealing assembly of claim 1, wherein said energizer element includes void space within said energizer element.

7. The sealing assembly of claim 6, wherein said void space comprises a plurality of gas filled closed cell cavities.

8. The sealing assembly of claim 1, wherein said anti-rotation projection is made of a substantially rigid material.

9. The sealing assembly of claim 8, wherein said anti-rotation projection comprises a pin.

10. The sealing assembly of claim 9, wherein said pin includes a shank having a shank dimension and a head having a head dimension that is greater than said shank dimension.

11. The sealing assembly of claim 10, wherein said pin head includes a retaining groove for securing said pin to said seal body.

12. The sealing assembly of claim 10, wherein said pocket recess has a pocket dimension, said pocket dimension being greater than said shank dimension and said head dimension being greater than said pocket dimension.

13. A compression-type rotary seal comprising:
a seal body of generally ring-like-construction, said seal body having a predetermined modulus of elasticity, said seal body having an annular recess defining a plurality of retaining ridges and retaining depressions, said annular recess having a first volume in an uninstalled condition and a second volume in a compressed, installed condition of the seal;
an energizer element engaging said plurality of retaining ridges and retaining depressions in said annular recess, said energizer element having a modulus of elasticity that is different than said predetermined modulus of elasticity of said seal body, said energizer element having a volume in said compressed, installed condition that is no greater than said second volume of said compressed annular recess; and
an anti-rotation projection engaged to said seal body, said anti-rotation projection extending from said seal body.

14. The compression-type rotary seal of claim 13, wherein said modulus of elasticity of said energizer element is lower than said predetermined modulus of elasticity of said seal body.

15. The compression-type rotary seal of claim 13, wherein said energizer element is made of a castable material.

16. The compression-type rotary seal of claim 15, wherein said energizer element is cast in said seal body annular recess to form a mechanical interlock with said plurality of retaining ridges and depressions in said annular recess.

17. The compression-type rotary seal of claim 13, wherein said energizer element remains entirely within said annular recess when in said compressed, installed condition.

18. The compression-type rotary seal of claim 13, wherein said energizer element includes void space within said energizer element.

19. The compression-type rotary seal of claim 18, wherein said void space comprises a plurality of gas filled closed cell cavities.

20. The compression-type rotary seal of claim 13, wherein said anti-rotation projection is made of a substantially rigid material.

21. The compression-type rotary seal of claim 20, wherein said anti-rotation projection comprises a pin having a shank and an enlarged head, said enlarged head including a retaining groove for securing said pin to said seal body.

22. A compression-type rotary seal comprising:
a seal body of generally ring-like construction having an annular recess, said annular recess having a first volume in an uninstalled condition and a second volume in a compressed, installed condition of the seal, said seal body having a predetermined modulus of elasticity; and
an energizer element engaging said annular recess, said energizer element having a modulus of elasticity that is different than said predetermined modulus of elasticity of said seal body, said energizer element having a volume in said compressed, installed condition that is no greater than said second volume of said compressed annular recess.

23. The compression-type rotary seal of claim 22, wherein said seal body annular recess defines a plurality of retaining ridges and retaining depressions and said energizer element engages said plurality of retaining ridges and retaining depressions in said annular recess.

24. The compression-type rotary seal of claim 22, wherein said modulus of elasticity of said energizer element is lower than said predetermined modulus of elasticity of said seal body.

25. The compression-type rotary seal of claim 23, wherein said energizer element is made of a castable material.

26. The compression-type rotary seal of claim 25, wherein said energizer element is cast in said seal body annular recess to form a mechanical interlock with said plurality of retaining ridges and depressions in said annular recess.

27. The compression-type rotary seal of claim 22, wherein said energizer element remains entirely within said annular recess when in said compressed, installed condition.

28. The compression-type rotary seal of claim 22, wherein said energizer element includes a void space within said energizer element.

29. The compression-type rotary seal of claim 28, wherein said void space comprises a plurality of gas filled closed cell cavities.

30. A sealing assembly comprising:
a first machine component defining a seal groove adjoined to a pocket recess;
a second machine component having a relatively rotatable surface; and
a rotary seal in sealing engagement with said first and second machine components, said rotary seal comprising:
a seal body of generally ring-like construction, said seal body defining a dynamic sealing lip having a dynamic sealing surface; and
an anti-rotation projection extending from said seal body into said pocket recess of said first machine component, said anti-rotation projection being made of a substantially rigid material.

31. The sealing assembly of claim 30, wherein said anti-rotation projection comprises a pin including a shank having a shank dimension and a head having a head dimension that is greater than said shank dimension.

32. The sealing assembly of claim 31, wherein said pin head includes a retaining groove for securing said pin to said seal body.

33. The sealing assembly of claim 31, wherein said pocket recess has a pocket dimension, said pocket dimension being greater than said shank dimension and said head dimension being greater than said pocket dimension.

34. The sealing assembly of claim 31, wherein said seal body includes an annular recess.

35. The sealing assembly of claim 34, further comprising an energizer element received in said annular recess.

36. The sealing assembly of claim 35, wherein said seal body has a predetermined modulus of elasticity and said energizer element has a modulus of elasticity that is different than said seal body predetermined modulus of elasticity.

37. The sealing assembly of claim 36, wherein said modulus of elasticity of said energizer element is greater than said seal body predetermined modulus of elasticity.

38. The sealing assembly of claim 37, wherein said energizer element is a spring.

39. A compression-type rotary seal comprising:
a seal body of generally ring-like construction, said seal body having a predetermined modulus of elasticity, said seal body having an annular recess defining a plurality of retaining ridges and retaining depressions;
an energizer element engaging said plurality of retaining ridges and retaining depressions in said annular recess, said energizer element having a modulus of elasticity that is different than said predetermined modulus of elasticity of said seal body.

40. The compression-type rotary seal of claim 39, wherein said modulus of elasticity of said energizer element is lower than said predetermined modulus of elasticity of said seal body.

41. The compression-type rotary seal of claim 39, wherein said energizer element is made of a castable material.

42. The compression-type rotary seal of claim 41, wherein said energizer element is cast in said seal body annular recess to form a mechanical interlock with said plurality of retaining ridges and depressions in said annular recess.
